(19) United States
(12) Patent Application Publication
(10) Pub. No.: US 2013/0047177 A1
(43) Pub. Date: Feb. 21, 2013

(54) METHOD AND SERVER FOR DETECTING A VIDEO PROGRAM RECEIVED BY A USER

(71) Applicants: Gérard Delegue, Nozay (FR); Sylvain Squedin, Nozay (FR)

(72) Inventors: Gérard Delegue, Nozay (FR); Sylvain Squedin, Nozay (FR)

(21) Appl. No.: 13/581,143

(22) PCT Filed: Feb. 21, 2011
(86) PCT No.: PCT/EP2011/052482

§ 371 Date: Nov. 7, 2012

(30) Foreign Application Priority Data
Feb. 24, 2010 (FR) 1051309

(51) Int. Cl. H04N 21/442

(52) U.S. Cl. 725/18

(57) ABSTRACT

This method for identifying a video programme received by a user (UE), by identifying an audio sequence contained within that video programme, consists of; receiving (1-6) a plurality of reference audio sequences, and receiving, for each of those sequences, a signature and a reference audio signature identifier, —preselecting (8) a series of reference audio signature identifiers, then correlating (9) the signatures respectively corresponding to these preselected identifiers, with a signature representing an audio sequence contained within the video programme received by the user, and selecting from among the preselected identifiers the one which exhibits the greatest correlation, in order to identify an audio sequence, and thereby to identify the video programme received by the user; In order to preselect a series of reference audio signature identifiers, it consists of particularly taking into account information describing the video programme received by the user, which is provided by a programme guide that is distributed in parallel with the is video programmes to be identified.

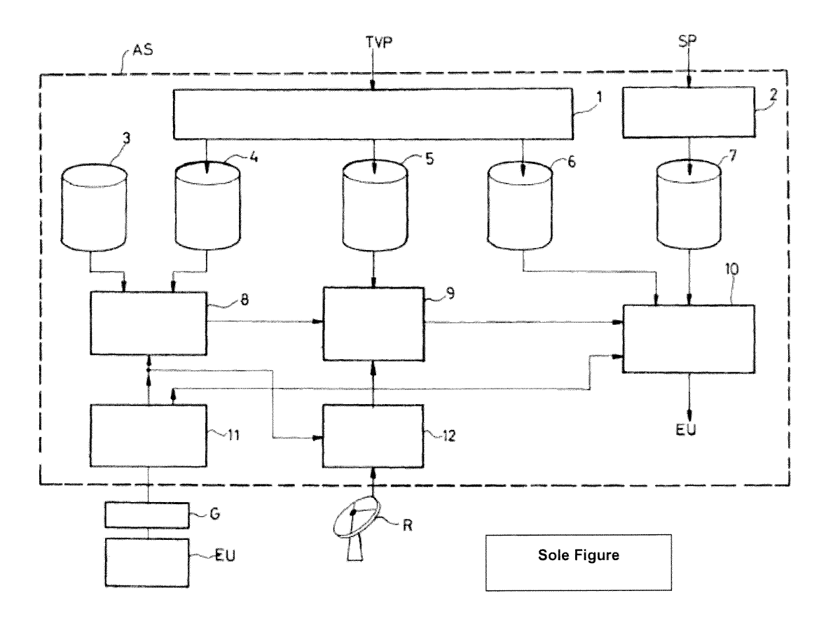

The invention relates to a method and a server for identifying a video sequence of a video programme within a stream of video programmes received by a user, this stream being carried over a terrestrial television network, or over a cable television network, or over a mobile telephony network, or over the Internet, etc., in broadcast mode or peer-to-peer mode. If broadcast mode is used (terrestrial transmission, for example), additional services specific to a given user may be provided via another channel, such as the Internet. If peer-to-peer mode is used, additional services specific to a given user may be provided via the same channel, such as the Internet. For example, the company Activevideo (http://www.activevideo.com) offers video streams carried over the Internet and which each combine a conventional television programme and interactive web services. Each flow is a single MPEG stream constructed by an Internet-connected server, and sent to a single user. If the video sequence being received by a user is successfully identified, it is possible to offer the user additional services that correspond exactly to the identified sequence: commercial offers, entertainment options, information, advertising, etc.

This identification is difficult. For this identification, two tools may be used, which were designed to enable a user to choose a video programme:
A scheduled time (particularly one published in the press) describes the content of the programmes in each package of video programmes in advance.
An electronic guide is associated with each package in order to describe the current programme on each video stream of that package, at the time when that guide is consulted.

However, this information is not precise enough to identify a programme with certainty, let alone to identify a video sequence within a programme, because these tools do not describe the programmes at a fine level, sequence by sequence. Furthermore, many programmes are delayed past the scheduled time, or even replaced at the last minute. It is therefore necessary to find a more accurate method for identifying a video sequence.

It is conceivable to identify a video sequence by identifying the audio sequence that it contains. Methods for identifying an audio sequence are known. The document WO 2008/042953 describes a method for identifying an audio sequence, such as a song received by a mobile telephone. This known method consists of recording that audio sequence, then of sending it to a server that stores reference signatures that respectively represent many audio sequences. Each reference signature had previously been calculated based on a known audio sequence, during an interval of time lasting several seconds to several minutes. Each signature is made up, for example, of energy measurements respectively within a plurality of segments of the frequency spectrum. The known identification method consists of calculating a series of signatures based on the received audio sequence, and correlating each calculated signature with each archived reference signature. When a calculated signature corresponds to an archived reference signature, the server sends the user the identity associated with that reference signature (a song title) and an excerpt of the corresponding audio sequence (the song), which had previously been stored with the reference signature, in order to ask the user to confirm the identification. Next, the server offers the user a service (Buy the song identified this way). The shortcoming of the known methods is the slowness of identification, due to the large number of reference signatures to correlate with each signature calculated based on a received audio sequence.

The purpose of the invention is to remedy this slowness, while making it possible to easily modify the choice of audio sequences to be identified, in order to quickly adapt them to new services to be offered to the users.

The object of the invention is a method for identifying a video programme received by a user, by identifying an audio sequence contained within that video programme, comprising the steps consisting of:
receiving a plurality of reference audio sequences, and receiving, for each of those sequences, a signature and a reference audio signature identifier,
preselecting (8) a series of reference audio signature identifiers, taking into account the information that describes the video programme received by the user and is provided by a programme guide broadcast in parallel with the video programme to be identified.
   then correlating the signatures respectively corresponding to these preselected identifiers, with a signature representing an audio sequence contained within the video programme received by the user, and selecting from among the preselected identifiers the one which exhibits the greatest correlation, in order to identify an audio sequence, and thereby to identify the video programme received by the user;

characterized in that, in order to preselect a series of reference audio signature identifiers, it further consists of:
receiving a command message indicating that the user wishes to benefit from additional services, which message contains data identifying the user, identifying the channel that the user is receiving, and the date and time of the command;
and additionally taking this data into account in order to preselect a series of reference audio signature identifiers.

In pre erred embodiments, the inventive method further consists of:
receiving a semantic description of the reference audio sequence corresponding to the identifier of the recognized audio sequence,
receiving the descriptions that respectively correspond to additional services hat may be offered to the user,
then comparing this semantic description to descriptions that respectively correspond to additional services that may be offered to the user, and selecting at least one additional service to offer the user in question;
and finally, to activate this additional service for the user in question.

In preferred embodiments, the inventive method further consists of activating the selected service only if the user has transmitted a message indicating that he or she wants to benefit from additional services.

The invention will be better understood, and other characteristics will become apparent upon reading the following description of the sole figure accompanying it: This sole figure functionally depicts an example of a conventional application server AS executing software means suitable to implement the inventive method.

A user EU, considered by way of example, has a television set connected to the Internet (not depicted) by a gateway G. This gateway G comprises software means enabling it to communicate via the Internet with the AS server and with an Internet service provider in order to receive a package of video programmes, and to benefit from additional web services connected with the video programme that it is receiving. The user EU has a remote control to send commands to this gateway, change the reception channel, or request to benefit from additional services.

This gateway G comprises software means enabling it to receive commands and transfer them:
to the Internet service provider, which sends a video programme and any additional services over the channel chosen by the user in question,
and to the server AS that uses the information contained in those commands in order to detect a command that is a request to benefit from additional services, and to facilitate the identification of the audio sequence being received.

The server AS is further connected to a satellite reception station R that receives all of the programmes of the package that a user such as the user UE can receive.
This server AS comprises:
   A software module 1 constituting an interface enabling a television producer TVP to provide the server AS with information describing video programmes to be identified (reference audio sequences, order of audio sequences within the video programme, respective identifiers of reference audio sequences, and respective semantic descriptions of reference audio sequences). The semantic description of a reference audio sequence will enable the AS server to determine the services to offer a user when an identical audio sequence is identified in a video programme received by that user. The module 1 determines a signature for each reference audio sequence, and associates a reference audio sequence identifier.
   A software module 2 constituting an interface enabling a service provider SP to provide the server AS with information describing additional services that may be offered during the identification of reference audio sequences, in the video programme received by a user.
   A software module 3 for writing and reading in a programme guide memory (Titles, channels used, hours). This guide is distributed at the same time as each of the package's video programmes.
   A software module 4 for writing and reading, in a memory, some of the information (order of audio sequences, and respective identifiers of reference audio sequences) describing the video programmes to be identified.
   A software module 5 for writing and reading, in a memory, the signatures representing the reference audio sequences.
   A software module 6 for writing and reading, in a memory, the semantic descriptions of the audio sequences.
   A software module 7 for writing and reading, in a memory, the descriptions of the additional services.
   A software module 8 for preselecting a series of reference audio sequence signature identifiers, from among the identifiers that respectively correspond to the signatures stored by the module 4, particularly as a function of information describing the programme received by the user, which are provided by a programme guide that is distributed in parallel with the video programmes to be identified, this programme guide (Titles, channels used, scheduled times) being provided by the module 3.
A software module 9 for:
   receiving a signature representing an audio sequence extracted from the video programme that a user, for example EU, is receiving, —receiving the series of reference audio sequence signature identifiers preselected by the module 8,
   reading the signatures that respectively correspond to those preselected identifiers, via the module 5,
   then correlating the reference signatures read in this way with the signature representing the audio sequence extracted from the video programme that the user EU is receiving,
   and selecting from among the preselected identifiers the one that exhibits the strongest correlation, in order to identify a received audio sequence, and thereby to identify the video programme being received by the user EU.
A software module 10 for:
   reading, via the module 6, the semantic description of a reference audio sequence that corresponds to the identifier of the received audio sequence,
   then reading, via the module 7, the descriptions of the additional services and comparing them with the semantic description of the received audio sequence, and thereby to identify one or more additional services that correspond to that semantic description.
   and finally, offering those additional service(s) to the user in question EU.
A software module 11 for:
   receiving, from the gateway G via the Internet, all of the command messages transmitted by a user, such as the user EU, addressed either to the server AS, or to the Internet service provider.
   saving this data, then retransmitting it to the module 8, which takes them into account in order to preselect a series of reference audio sequence signature identifiers.
A software module 12 connected to the station R in order to be able to receive all the programmes that a user can receive, particularly the user UE, and connected to the module 11 for receiving the identifier of the channel that the user in question UE is receiving;
which module 12 comprises software means for:
   selecting the programme that is received by the user in question EU, at the moment when that user EU is sending a command to the server AS in order to request to benefit from additional services,
   calculating a series of signatures successively representing audio sequences contained within the programme that is received by the user EU,
   and providing that series of signatures to the module 9.

For example, for an audio sequence accompanying a given advertisement, the television producer TVP indicates the “type of product” and the “brand” promoted by that advertisement. This semantic description is stored by the module 6. At the moment when that audio sequence is identified by the module 9, this semantic description enables the module 10 to determine a list of services to be offered to the user, by searching via the module 7 for the respective descriptions of additional services that correspond to that semantic description: for example, a web page or a telephone number that would make it possible to obtain additional information about that type of product and that brand. The television producer TVP does not directly associate the audio sequences with well-identified services. This makes it possible to independently manage the services and audio sequences. For example, when an audio sequence associated with a TV series is first broadcast, the sale of the corresponding DVD may be offered, and afterwards other services may be offered such as the sale of figurines, the sale of clothes identical to those worn by the actors, etc.

According to a first embodiment, the user can only transmit one channel selection command, intended for the Internet service provider and containing a channel identifier to change the channel. The software module 10 activates an additional service for the user in question EU, once a predetermined audio sequence had been detected, without the user having asked to benefit from additional services.

According to a second embodiment, the user can transmit two types of commands:
a channel-selecting command, intended for the Internet service provider and containing a channel identifier to change the channel.
or a command to request additional services, containing data identifying the user, identifying the channel that the user is receiving, as well as the date and time of the command.

According to the first embodiment, the software module 8 for preselecting a series of reference audio sequence signature identifiers only takes into account the information provided by the programme guide (Titles, channels used, scheduled times), via the module 3, for the channel selected by the last channel-selecting command. Additionally, the module 10 activates an additional service for the user in question EU within the involvement of the module 11.

According to the second embodiment, the software module 8 further takes into account the data contained within each command requesting additional services. It thereby knows at what date and time the user expressed a desire to benefit from additional services. That date and that time correspond to a certain piece of content of the received programme, which drew the user's interest for at least one additional service potentially associated with that content. This makes it possible to determine with greater accuracy what additional service interested the user. The offered service will probably be better-suited and therefore more appreciated by the user. Additionally, the module 10 is connected to the module 11 in such a way that the module 10 activates an additional service only when it receives a command signal provided by the module 11, meaning when the module 11 receives a command requesting additional services, transmitted by the user EU.

In the two embodiments, thanks to the fact that it takes into account at least the guide's information, provided by the module 3, the software module 8 preselects the most likely audio sequences. The preselected identifiers are much fewer in number than the identifiers corresponding to the set of signatures stored by the module 4. The number of correlation calculations to carry out for each audio sequence to be identified is therefore heavily reduced. Consequently, the identification of a video programme is much faster than by known methods.

1) A method for identifying a video programme received by a user (EU), by identifying an audio sequence contained within that video programme, comprising:
receiving a plurality of reference audio sequences, and receiving, for each of those sequences, a signature and a reference audio sequence identifier,
preselecting a series of reference audio signature identifiers, taking into account the information describing the video programme received by the user, and which are provided by a programme guide which is broadcast in parallel with the video programme to be identified,
then correlating the signatures respectively corresponding to these preselected identifiers, with a signature representing an audio sequence contained within the video programme received by the user, and selecting from among the preselected identifiers the one which exhibits the greatest correlation, in order to identify an audio sequence, and thereby to identify the video programme received by the user; and,
in order to preselect a series of reference audio signature identifiers, further comprising:
receiving a command message indicating that the user wishes to benefit from additional services, which message contains data identifying the user, identifying the channel that the user is receiving, and the date and time of the command;
and additionally taking this data into account in order to preselect a series of reference audio signature identifiers.

2) A method according to claim 1, further comprising:
receiving a semantic description of the reference audio sequence corresponding to the identifier of the recognized audio sequence,
receiving the descriptions that respectively correspond to additional services that may be offered to the user,
then comparing this semantic description to descriptions that respectively correspond to additional services that may be offered to the user, and selecting at least one additional service to offer the user in question;
and finally, to activate this additional service for the user in question.

3) A method according to claim 2, wherein an additional service is only activated if the user (EU) transmitted a message indicating that he or she wishes to benefit from additional services.

4) A server (AS) for identifying a video programme received by a given user (UE), by identifying an audio sequence associated with the video programme to be identified, wherein the server comprises software means for implementing the method according to claim 1.
